(19) United States
(12) Patent Application Publication
(10) Pub. No.: US 2017/0255901 A1
(43) Pub. Date: Sep. 7, 2017

(54) Geospatial Database for Maintaining Produce Quality

(71) Applicant: INTERNATIONAL BUSINESS MACHINES CORPORATION, Armonk, NY (US)

(72) Inventors: Sergio A. Bermudez Rodriguez, Boston, MA (US); Nigel C.P. Hinds, Great Barrington, MA (US); Levente Klein, Tuckahoe, NY (US); Fernando J. Marianno, New York, NY (US)

(21) Appl. No.: 15/058,337

(22) Filed: Mar. 2, 2016

(51) Int. Cl. G06Q 10/08; G06F 17/30

(52) U.S. Cl. CPC G06Q 10/0833; G06F 17/30477

(57) ABSTRACT

Described herein is a method of managing quality of perishable items traveling in a supply chain. An initial estimated salable lifetime of perishable items is determined. In real time, the initial estimated salable lifetime is reduced to an estimated remaining salable lifetime in a determination based on information including one or more conditions relating to the environment to which the perishable items are exposed and the transporting of the perishable items to a final destination. A manner of preserving the estimated remaining salable lifetime of the perishable items is determined by at least one of slowing the depletion of the estimated remaining salable lifetime and changing a transportation itinerary of the perishable items. Action is taken in accordance with the determination, and the estimated remaining salable lifetime of the perishable items is preserved.

### BACKGROUND

Technical Field

The present invention relates to a database for managing perishable items in a supply chain, and more particularly to a database for managing perishable items in a supply chain in order to preserve a maximum useful life when they arrive at a final destination, e.g., a point of retail sale.

Description of the Related Art

Supply chain management software may be able to track the location of products as they pass through the supply chain, from harvest time, combined with the time and location the product enters the supply chain to the time and location the product leaves the supply chain. Such software may also be capable tracking the quantity of units passing through the supply chain. The tracking software may also be able to keep track of other information associated with the product, such as the expiration date(s) and/or sell-by dates of perishable items.

The freshness of a perishable item (e.g., produce) as it travels through a supply chain is a consideration that may be separate and apart from an expiration date or a sell-by date. For example, the quality and useful life of a perishable item may deteriorate as it moves through the supply chain to an extent that it becomes non-salable. The perishable item may arrive at the point of sale with only a very small period of acceptable freshness or salable life left. Produce in a deteriorated condition may be detected by one or more sensory perceptions, such as its appearance, feel, and smell. In such a situation, decisions may have to be made quickly on what to do with deteriorated produce—such as whether it should be sold, and if so, for how long, and at what price in order to move the item off the shelves. The price may have to be discounted to make it appealing to the consumer. The amount of salable time that remains as produce arrives at the point of sale may be related to the amount of freshness left in the produce, which could factor into the price that the produce can command.

In addition to commanding a relatively higher price for produce at its freshest, there are other reasons why receiving produce at its freshest is desirable. For example, being known as the seller of the freshest goods raises the seller's professional reputation.

### SUMMARY

According to an embodiment of the present principles, described herein is a computer-implemented method of managing the quality of perishable items traveling in a supply chain. In the method, an initial estimated salable lifetime of perishable items is determined. In real time, the initial estimated salable lifetime is reduced to an estimated remaining salable lifetime in a determination based on information including one or more conditions relating to the environment to which the perishable items are exposed and the transporting of the perishable items to a final destination. In a hardware processor, a manner of preserving the estimated remaining salable lifetime of the perishable items is determined by at least one of slowing the depletion of the estimated remaining salable lifetime and changing a transportation itinerary of the perishable items. Action is taken in accordance with the determination, and the estimated remaining salable lifetime of the perishable items is preserved.

Further in accordance with present principles, described is a system for managing the quality of perishable items traveling in a supply chain. The system includes one or more processors including memory. The system includes geospatial database system that has one or more inputs through which information concerning the perishable items and the transporting of same are delivered to the system. The geospatial database system has data storage levels configured to collect and store data concerning the perishable items, the environmental conditions to which the perishable items are exposed, and the transporting of the perishable items to a final destination. A calculation region is provided in the geospatial database system in which, based on the data, an estimated remaining salable lifetime of the perishable item and manners of preserving the estimated remaining salable estimated lifetime of the perishable item are determined. The system has outputs in which collected data and determinations are distributed.

Still further in accordance with present principles, described is a computer program product for managing the quality of perishable items traveling in a supply chain, the computer program product comprising a non-transitory computer readable storage medium having program instructions embodied therewith, the program instructions being executable by a computer to cause the computer to perform a method in which an initial estimated salable lifetime of perishable items is determined. In real time, the initial estimated salable lifetime is reduced to an estimated remaining salable lifetime in a determination based on information including one or more conditions relating to the environment to which the perishable items are exposed and the transporting of the perishable items to a final destination. In a hardware processor, a manner of preserving the estimated remaining salable lifetime of the perishable items is determined by at least one of slowing the depletion of the estimated remaining salable lifetime and changing a transportation itinerary of the perishable items. Action is taken in accordance with the determination, and the estimated remaining salable lifetime of the perishable items is preserved.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 shows an exemplary embodiment of a processing system to which the present principles may be applied;

FIG. 2 depicts an exemplary embodiment of a geo spatial database for maintaining the quality of perishable items, e.g., produce, in accordance with an embodiment of the present principles;

FIG. 3 depicts an exemplary embodiment of data-collecting sensors associated with a packing crate that may be employed with a geospatial database in accordance with an embodiment of the present principles;

FIG. 4 depicts an exemplary embodiment of data-collecting sensors associated with a semitrailer in which goods are trucked over distances that may be employed with a geospatial database in accordance with an embodiment of the present principles;

FIG. 5 depicts an exemplary embodiment of a system incorporating a geospatial database for maintaining the quality of perishable items, e.g., produce, in accordance with an embodiment of the present principles;

FIG. 6 depicts an exemplary embodiment of a method for maintaining the quality of perishable items, e.g., produce, in accordance with an embodiment of the present principles;

FIG. 7 depicts a map of the United States showing potential transportation routes and storage warehouses that may be used in transporting perishable items on a cross-country journey, the map being used in a description of an exemplary embodiment in accordance with the present principles;

FIG. 8 shows an exemplary cloud computing node in accordance with an embodiment of the present principles;

FIG. 9 shows an exemplary cloud computing environment in accordance with an embodiment of the present principles; and

FIG. 10 shows exemplary abstraction model layers, in accordance with an embodiment of the present principles.

### DETAILED DESCRIPTION

Geospatial databases may have multiple data layers that have location and time stamp information encoded on which fast computations generating further information and data may occur. The database structure includes non-spatial business information, such as for example freshness quality index for products, store buying patterns, store demand for certain products, selling time of produce). Other examples of non-spatial information include product price, popularity (e.g., per social media), product demand, and the availability of the same or similar items in other stores in the same area. In one embodiment according to present principles, a geospatial database is employed in tracking and monitoring perishable items, e.g., produce and other farm products moving from a starting point (e.g., a place of harvest) to an final destination (e.g., a distribution point or a retail stores such as a supermarket). The geospatial database collects and stores different kinds of information regarding the factors that could affect the freshness of perishable items moving through the supply chain in order to maximize, e.g., preserve the expected or estimated remaining salable lifetime of the perishable items upon arrival at the final destination. The information is analyzed in the geospatial database to generate additional information and data on how to maximize the estimated remaining salable lifetime of the perishable items moving through the supply chain.

Among the factors and conditions that are monitored are environmental conditions such as heat, temperature, light, and moisture. Other factors are considered, such as the distance between the starting and ending points, the available modes of transportation employed in transporting the produce, weather and road conditions, the estimated and actual travel time between destinations, and conditions at storage locations such as warehouses. Information concerning these factors are input into the data base.

The information being received by the geospatial database may be continuously analyzed and made the subject of various calculations such that the estimated remaining salable lifetime of the perishable items is maximized in the journey to a final destination, e.g., a retail place such as a supermarket. Conditions in the transportation mode, such as a truck, may be monitored and accounted for by the database. There may be intermediate locations to which the produce may travel on its journey, such as a warehouse, for example. Information concerning the warehousing can be monitored and input into the database, and attributes of the warehouse can be accounted for. Information on retail stores can also be collected and stored in the geospatial database.

In one embodiment, each type of perishable item (e.g., bananas, plums, apples, tomatoes, potatoes, peppers, etc.) has an initial expected salable lifetime value, e.g., an initial estimated salable lifetime dependent on various factors. In one embodiment, the produce may be designated an initial estimated salable lifetime, and as time passes as the produce moves through the supply chain, the estimated salable lifetime is adjusted, e.g., reduced to determine an estimated remaining salable lifetime, in response to the conditions encountered by the produce. For example, if produce is being transported in a semi-trailer from, e.g., California to the east coast of the United States, sensors in the proximity of the produce may monitor the environmental conditions and transmit this information to the geospatial database. For example, such sensors may be located within the produce packaging crates or within the cargo bay of a semi-trailer that contains the produce. The data transmitted may indicate that the produce is exposed to high temperatures, moisture, and light, which information may lead to a determination in the geospatial data base that the estimated remaining lifetime of the produce is being reduced at a relatively rapid rate. The sensors may be chemical sensors that detect the deterioration of the perishable item, such as through the emissions of methane and ethylene, which are produced by produce as it deteriorates. The transmitted data may be of the kind that indicates relatively slow deterioration of produce lifetime, such as temperatures, moisture, and light exposure that are at or near favorable conditions for maximizing the estimated remaining salable lifetime of the produce. In any event, from the data analysis and the determinations made by the geospatial database, a system user may be able to predict the condition of the produce at any point during its travels in a supply chain, including its arrival in at a final destination. A system user may also be able to adjust conditions in order to preserve and maximize the estimated remaining salable lifetime, such as for example adjusting the temperature, relative humidity, odor control, or illumination within the truck as the produce is in transit. Such adjustments may improve the condition of the produce upon its arrival at the final destination.

The freshness can be modeled as addition of dose function based on time and environmental parameters as a product moves through multiple stages, such as harvesting, initial storage, transport, warehousing and retail destination. Dose function accounts for the maximum exposure that a product can have to a certain environment before being permanently damaged. As produce moves from its starting point to a final destination, the geospatial database may factor in alternative transportation routes, road temperatures, position of the sun, shading, if any, that is affecting the transportation means, the amount of daylight, the heat load on the transportation means, and temperature in the cargo bay where the produce is stored. The geospatial database may optimize the shortest path to final destination, maximize the number of units sold per store, and maximize the shelf lifetime based on continuous calculations of environmental conditions stored in the geospatial database.

Freshness parameter data for different kinds of produce may be included in the geospatial data base. Such parameters may be one or more of color, texture, firmness, smell, surface defects (e.g., bruising, or lack thereof). The date of harvest is also related to freshness. Still further, freshness indices have been established for many products that can be related to the environmental condition like temperature and relative humidity.

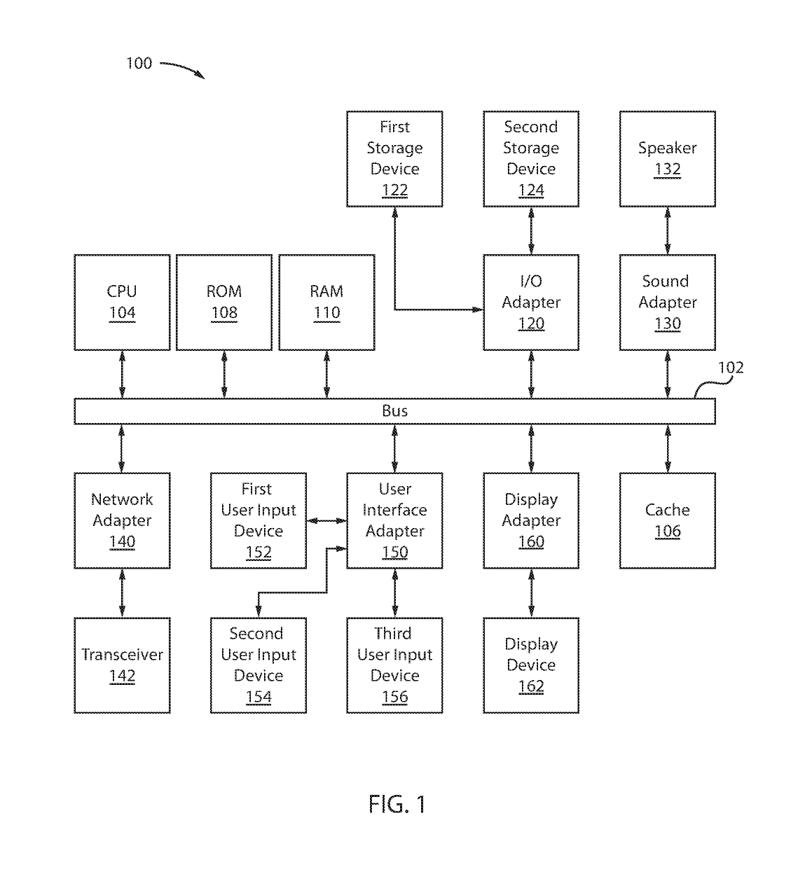

Referring now to the drawings in which like numerals represent the same or similar elements and initially to FIG. 1, an exemplary processing system 100 to which the present principles may be applied is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154 and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100. These input output devices can be sense and monitor conditions in the environments such as temperature, relative humidity or chemical sensors for sensing agents such as methane and ethylene that sense the onset of fruit and vegetable rot.

The processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. It is to be appreciated that the terms processors and controllers can be used interchangeably herein. These and other variations of the processing system 100 are readily contemplated by one of ordinary skill in the art given the teachings of the present principles provided herein.

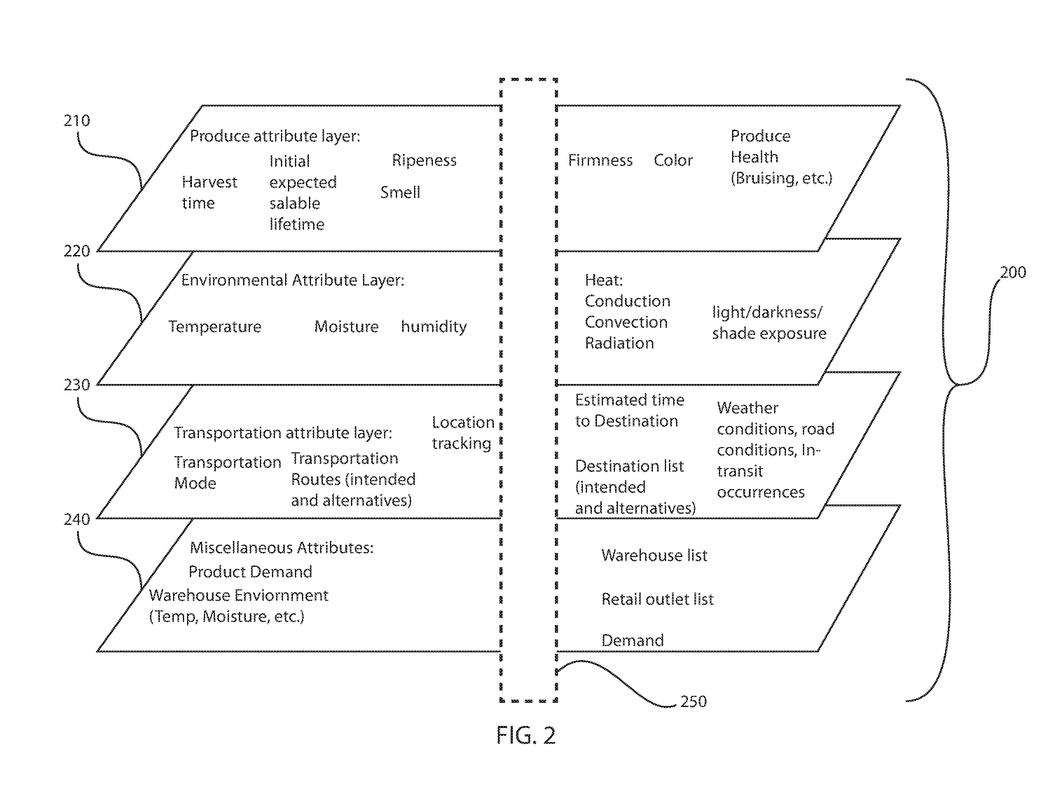

A geospatial database 200 according to an embodiment of the present principles is depicted in FIG. 2. The geospatial database 200 is comprised of one or more layers that contain and store data that is collected continuously in real time from sensors and which may be input to the database in other means. The data relates to, among other things, the conditions encountered by the perishable items as they travel from one location to another. In the embodiment depicted in FIG. 2, the geospatial database 200 has produce attribute layer 210, environmental attribute layer 220, transportation attribute layer 230 and miscellaneous attribute layer 240. The geospatial database 200 also has a calculation region 250 in which the data collected in the layers is analyzed and made the subject of calculations performed for purposes of determining the quality of the produce in real time and how the quality can be maintained so that the produce arrives at its end destination in its freshest possible state.

As shown in FIG. 2, the calculation region 250 is depicted vertically, extending through the layers. The depiction of the calculation region 250 in this way is intended to convey the understanding that the calculation region may draw data and information from one or more layers, as explained below.

Produce attribute layer 210 stores and collects information concerning the attributes of different produce items which factor into produce quality. Such information may include the harvest time, e.g., the date on which the produce was harvested in the field, the initial expected salable lifetime of the produce, and other factors, such as the ripeness of the produce, the firmness of the produce, the smell of the produce, and produce health, e.g., bruising. These factors are monitored and adjusted in real time, e.g., if produce becomes overly ripe, then this may shorten the salable life and freshness of the produce as it arrives at the point of sale. Calculations can also be made to estimate the prolonging of the estimated remaining salable lifetime by lowering the temperature or relative humidity in the transportation vehicle, in which an actuator receives a signal from the database and accordingly adjusts the environment to extend produce lifetime.

An additional method may be to change the chemical composition of the air in the truck, where a portion of the oxygen in the air is replaced by nitrogen in order to preserve freshness, such as by releasing air from the cargo bay and replacing same with nitrogen until a certain composition is achieved. This can be combined with illuminating the produce with light at wavelengths that do not cause the estimating remaining salable lifetime to be rapidly diminished.

The information stored and collected on the produce attribute layer 210 can be used to make an initial estimation of the salable life of the produce, which includes the time at which the produce is in a state of freshness. Furthermore, this information could be adjusted in real time, in accordance with the conditions encountered by the produce as it travels. For example, if the produce is traveling in truck that is hot, the salable life of the produce can be adjusted to be shorter than the initial salable life expectancy.

The salable life expectancy may differ for different kinds of produce. For example, lettuce maintained at about 0° C. will be in good condition about eight days after harvest, in fair condition about 20 days after harvest, and virtually unsalable 35 days after harvest. When lettuce is maintained at 10° C., it will be in good condition at about 5 days after harvest, fair condition at about 10 days after harvest, and unsalable at about 18 days after harvest. Different kinds of produce will have different profiles. For example, asparagus maintained at 10° C. is unsalable at about 12 days after harvest. The produce attribute layer may account for different expected salable lifetimes for different kinds of produce.

The environmental attribute layer 220 stores and collects information concerning the attributes of the environment and environments that the produce encounters in the supply chain. For example, the environmental attribute layer may collect and store information concerning the temperature, moisture, humidity, heat, and exposure to light to which the produce is exposed. This layer may also collect and store information regarding chemical emissions of the produce, e.g., the emission of one or more of methane and ethylene which may indicate that the produce is deteriorating. This information is updated in real time, to reflect any changes in the environment that the produce may experience. For example, upon harvesting, the produce may be in a high temperature setting, reflecting the heat of the day of harvest. The produce may be harvested in the rain, and therefore may have a high degree of moisture that could affect the quality of the produce. Likewise, a humid environment may have an effect on the freshness and salable life expectancy. Still further, placing the produce into a controlled environment such as a refrigerated warehouse or truck may have the effect of preserving the estimated remaining salable lifetime of the produce.

The information collected and stored the environmental attribute layer 220 may be initially collected and stored by sensors associated with the produce, such as sensors that monitor environmental temperature, moisture meters that monitor moisture, chemical sensors that monitor the emission of methane and/or ethylene by the produce, barometers, humidity meters, light detectors for measuring the color of the produce and how it is changing in time, heat sensors to detect the heat load, and light meters that measure the amount of light in the environment. The sensors may be attached to the produce, or they may be attached to the produce packaging, or they may be attached to the cargo bay of a semi-trailer that is transporting the produce. The sensors monitor the environmental conditions and transmit this information to the geospatial database.

Heat sensors may be associated with the produce and the environment in which it is stored and travels. For example, the heat generated by conduction, convection, and radiation may be monitored. Such information may be particularly useful in monitoring the heat that the produce is exposed to as it travels by truck. For example, solar radiation may cause the heat in the cargo bay to rise to a level that affects the expected salable life of the produce. If a truck gets stuck in traffic on a hot sunny day, moving at very low speed or not moving at all, heat levels may be expected to rise due to the heat transfer mechanisms of conduction and radiation, and due the absence of the convection effect that may occur as a truck moves down the highway at or near the speed limit. The sensors will send this information to the geospatial database, where it will be stored on the environmental attribute layer, and where it can be used in calculations to adjust truck route, choose a different route, lower temperature in the cargo area to maintain and/or extend the useful life of the produce, and adjust the air composition to minimize the reduction in freshness or emission of gases like ethylene or methane. This information can be collected in real time and processed by the geospatial database, with the adjustment and feedback being provided in real time.

Information on exposure to light may be collected and stored on the environmental attribute layer. Such information takes into account the amount of direct sunlight, position of the sun, cloud cover of the sky that the produce and/or the transportation vehicle encounters on the route. Sunlight exposure and time of the day can increase the heat and temperatures of the produce, which can affect the expected salable life. These calculations can be combined with vegetation cover of the roads that may provide shade to the truck, direction of the road in respect to the sun position, topography that may change the exposure to sun radiation. Travel at night, through overcast conditions, or, if possible, on a well-shaded route can reduce the amount of light to which the produce is exposed, which may have a positive effect on the expected salable life of the produce. This information can be collected by sensors mounted to a light-gathering area, such as the exterior of a semi-trailer. This information can be transmitted to the geospatial database 200 for collection and storage on the environmental attribute layer 220, and made available for calculations and determinations made in the calculation region 250.

The transportation attribute layer 230 stores and collects information concerning the attributes of the mode of transportation used to transport produce from a starting point to an end point. For example, the transportation attribute layer 230 may collect and store information concerning the transportation mode (truck, train, cargo ship), the company or entity that is doing the shipping, and other information such as identifying features concerning the truck and semitrailer (e.g., make, model, identification numbers, special features such as refrigeration). The transportation attribute layer may store information on intended and alternative transportation routes and whether there will be stops at warehouses.

Location tracking data, such as data transmitted by a global positioning system (GPS), may be transmitted to the geospatial database and stored on the transportation attribute layer 230. Estimated time to destination data may be collected and stored on this layer. Other travel-related information may be stored and collected in the transportation attribute layer. For example, a list of possible destinations (intended and alternatives) where the produce may be delivered may be stored here. Road conditions and weather conditions may be collected and stored here. For example, if it is known that a truck containing produce is due to travel through a zone where construction is causing significant delays, the geospatial database would collect and store this information on the transportation attribute layer, and the database may suggest an alternative route that bypasses the construction zone. The geospatial database may be configured to collect information such as road and weather conditions through a communication link established with the agencies in charge of such matters, such as the National Weather Service, the U.S. Department of Transportation, state highway agencies, and state and local police departments. Such information may be obtained by monitoring information posted on the websites of these agencies or information extracted from GPS signal of vehicles that travel on the roads and that would provide information about traffic delays, accidents, car speed, or road conditions.

The transportation mode may be equipped with location trackers, e.g., GPS tracking devices that transmits GPS tracking information to the database on the location of the transportation mode in real time, so it can be determined where the produce is at any time on its journey. The transportation attribute layer may collect and store information concerning the estimated time to the destination, and update this information in real time. The transportation attribute layer may track in-transit occurrences, such as road closures, road construction, and weather-related delays and closures that may affect the time in which the produce will reach its final destination. This information may be updated in real time, to reflect any transportation-related changes that may affect the expected salable lifetime that may remain when the produce reaches its destination.

The miscellaneous attribute layer 240 accounts for miscellaneous considerations, such as a list of warehouses and the locations thereof where the produce may be stored for parts of its expected salable lifetime, and information on the demand for the product (e.g., produce). Information on the environmental conditions in the warehouses may be stored on this layer

The calculation region 250 of the geospatial database performs various calculations and determinations that manage the quality of the produce, such as adjusting the initial expected salable lifetime of the produce in real time in response to the environmental conditions encountered by the produce, adjusting transportation routes of the produce, arranging and directing for the produce to go to a different final destination or intermediate storage facility in order maximize freshness and salable life. These are just some examples of the many different kinds of calculations that the calculation region 250 may perform. For example, the calculation region 250 may continuously adjust the initial produce salable lifetime to arrive at an estimated remaining salable lifetime based on the an initial salable lifetime value based on temperature, moisture, humidity, heat, and exposure to light. That value, when combined with time of arrival estimates taken from the transportation attribute layer 230, can be used to determine an estimated remaining salable lifetime of the produce at the time of arrival at a final destination. The estimated remaining salable lifetime determinations would be made in the calculation region 250.

This information can be used to control the environment within the truck by adjusting temperature and humidity in the cargo area, and the illumination or the composition of the air in the transportation vehicle to minimize the decay of the products.

This information could inform a store manager of the expected remaining salable life of produce when it reaches his or her store, the general level of freshness upon its arrival, and how long it can remain on store shelves before being unsalable. In another example, a regional distribution manager for a supermarket chain could request that the produce be transported to a different destination than the one originally intended, in response to problems encountered on the transportation route, or some other decision may be made that maximizes, e.g., preserves the remaining salable lifetime of the produce.

The calculation region 250 can draw upon the various kinds of information stored on the different layers of the geospatial database 200 to make numerous determinations affecting the freshness and salable life. In one embodiment, various algorithms may be employed to make the calculations.

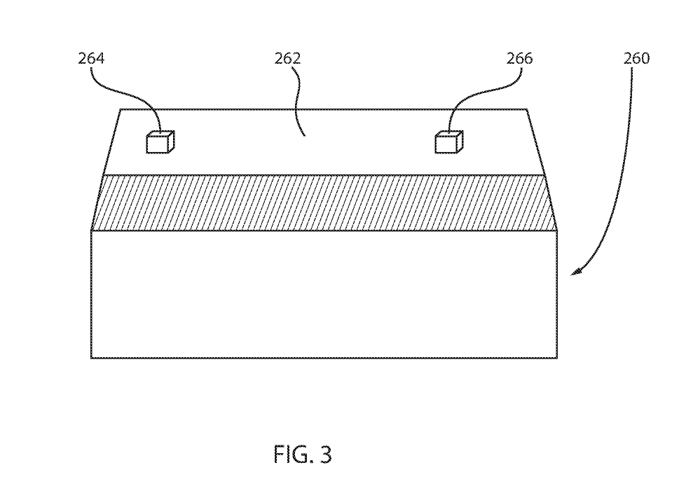

Turning now to FIG. 3, depicted is a produce packaging crate 260 provided with sensors 264, 266 affixed to the lid 262 of the crate 260. In this arrangement, the sensors are in the produce environment (no produce is shown in the crate). In this arrangement, the produce would be expected to collect accurate information concerning the environment of the produce. Sensors 264, 266 are merely exemplary and may detect information such as temperature, moisture, humidity, heat, light, emissions of chemicals (e.g., methane, ethylene), other environmental factors as well as impact or acceleration, which could indicate mishandling of the produce packages. The sensors may be provided with wireless transmitters, in communication with a control unit located in the transportation vehicle, which transmits information wirelessly to the geospatial database.

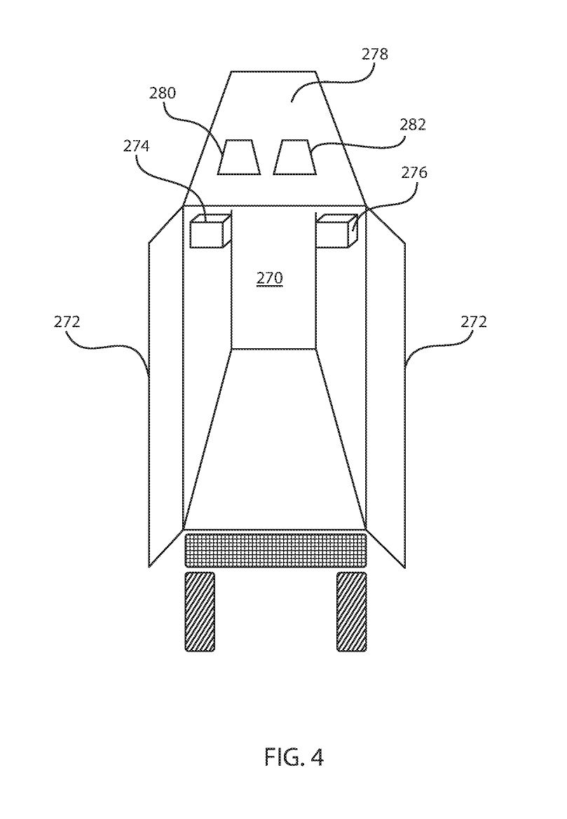

Turning now to FIG. 4, depicted is a semitrailer 270 with its doors 272 open to show its (empty) cargo bay. Sensors 274, 276 are affixed to the interior of the roof 278 of the semitrailer 270. In this arrangement, the sensors are positioned in the environment that the produce will travel in, and as such, the sensors would be expected to collect accurate information concerning the environment of the produce. Sensors 274, 276 are merely exemplary and may detect information such as temperature, moisture, humidity, heat, light, and other environmental factors. Sensors can be set at different heights within the cargo bay to measure air stratification and calculate changes in the expected freshness based on the crate location within the cargo bay.

The exterior of the roof 278 of the semitrailer is provided with additional sensors 280, 282 that detect information from the outside environment, such as heat, temperature, moisture, etc. One or more sensors may be a GPS tracking unit for determining the location of the transportation vehicle at any time. The GPS tracking unit may be located in the cab pulling the semitrailer. The sensors may be provided with wireless transmitters, in communication with a control unit located in the transportation vehicle, which transmit and receive information wirelessly to and from the geospatial database. Received information can be adjustment of environmental conditions (e.g., adjust temperature and humidity to preserve remaining salable lifetime), truck route changes, and travel information to improve freshness.

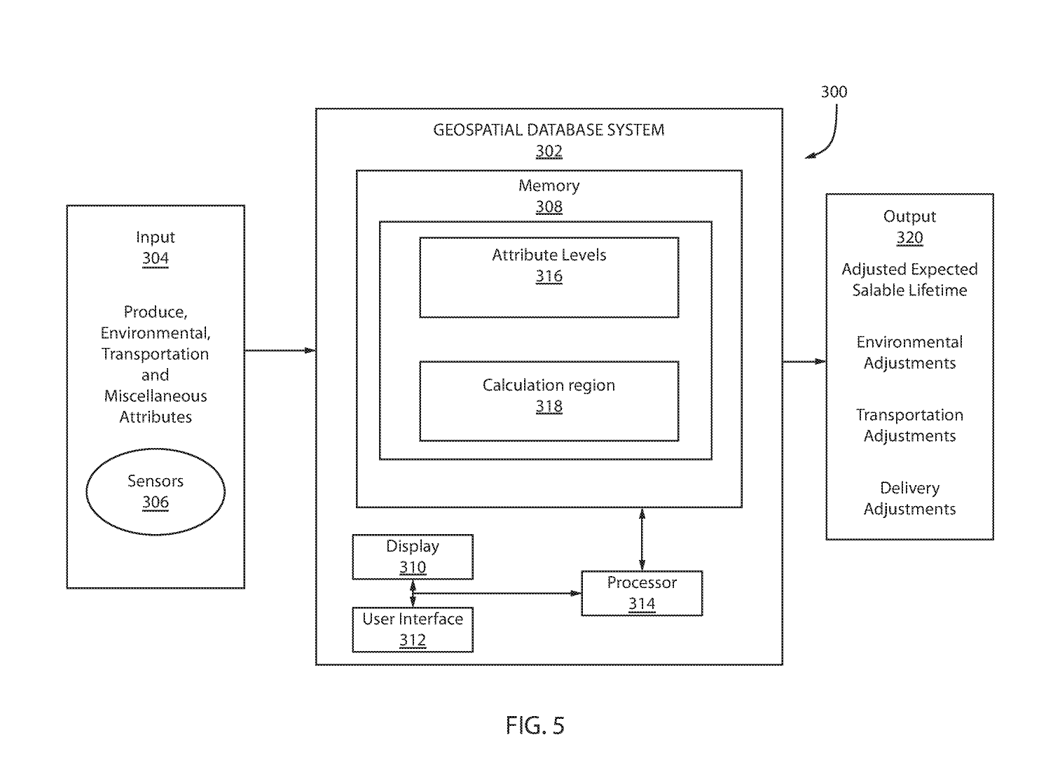

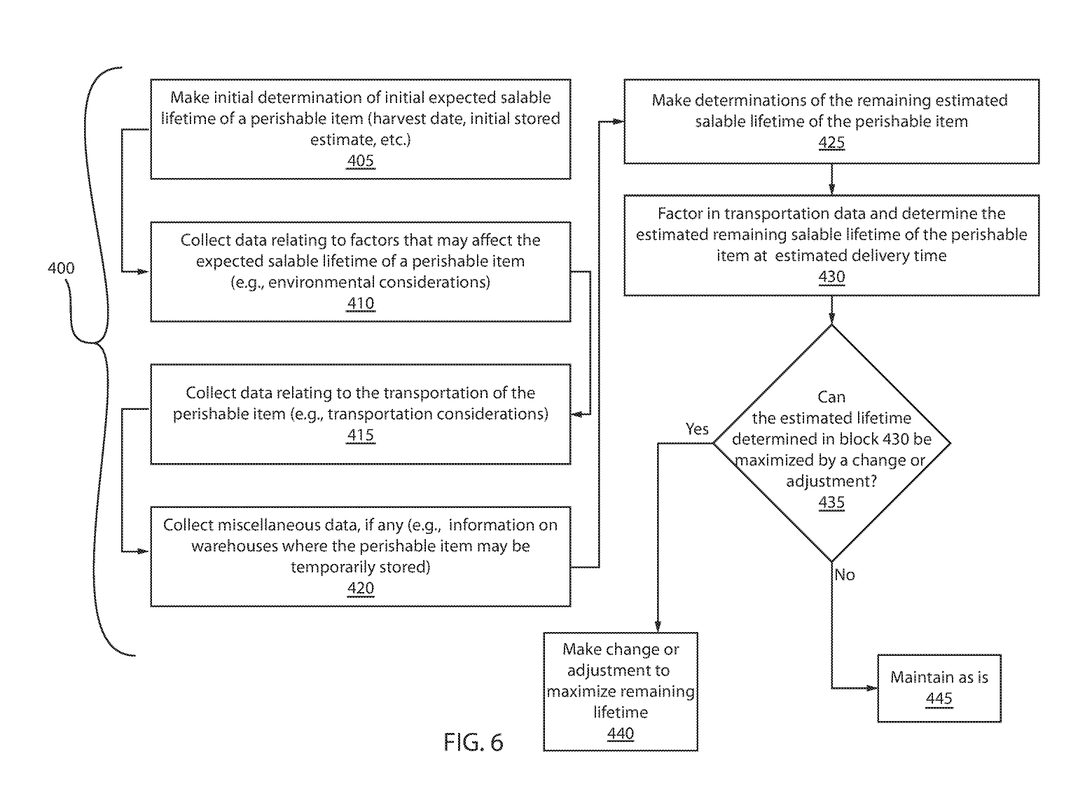

With reference to FIG. 5, a system 300 for maintaining produce quality is depicted. The system may implement embodiments of the present principles. Part or all of processing system 100 may be implemented in one or more of the elements of system 300. Further, it is to be appreciated that processing system 100 may perform at least part of the method described herein including, for example, at least part of method 400 described in association with FIG. 6. Similarly, part or all of system 300 for maintaining produce quality may be used to perform at least part of method 400 of FIG. 6.

System 300 for maintaining produce quality is shown with respect to an operational environment in which it can be utilized, in accordance with an embodiment of the present principles. System 300 for maintaining produce quality preferably includes a geospatial database system 302 that includes one or more processors 314 and memory 308 for storing applications, modules and other data. In one embodiment, the memory unit 308 includes a large number of memory blocks e.g., where a geospatial database may be stored and where calculations and data analysis may be performed. The system 300 may also include one or more displays 310 for viewing content. The display 310 may permit a user to interact with the system and its components and functions. This may be facilitated by the inclusion of a user interface 312, which may include a mouse, joystick, or any other peripheral or control to permit user interaction with the system and/or its devices. It should be understood that the components and functions of the system may be represented as one or more discrete systems or workstations, or may be integrated as part of a larger system or workstation.

System 300 is depicted as a computer-implemented system for managing produce quality to provide for the delivery of produce in a timely manner, thereby preserving the expected remaining salable lifetime of produce and maximizing sales opportunities. By managing the conditions under which produce is brought from farm to market, all involved in the supply chain can maximize efforts to bring produce to the point of sale in its freshest possible condition, thereby meeting consumer expectations of quality and the seller's desire to be fairly compensated for quality goods.

System 300 receives input 304, which may be information received from sensors associated with the produce, as described above. Input may also be in the form of information received from a user or system operator, for example a farm manager inputting information concerning the harvesting of a crop, e.g., the data of harvest and the environmental conditions of the harvest. Such input information may include the qualities of the crop at the time of harvest (color, firmness, ripeness, and health, e.g., bruising, or absence thereof). Other input information may be directed to known information about produce that has been developed through experience, e.g., empirically or through trial and error, regarding the initial expected salable lifetime for the produce. Such information may be input and stored in the system prior to harvesting. Other kinds of information may be obtained through establishing communication links with pertinent agencies, such as the U.S. Department of Agriculture, the U.S. Department of Transportation, the National Weather Service, state highway agencies and state and local police departments. The geospatial database may link directly to such agencies, or it may monitor the websites of such agencies to receive information.

Other information that may be input into the system includes information transmitted from sensors 306, for examples, the kinds of sensors as described above. For example, the transmitted information may include environmental conditions such as temperature, moisture, humidity, heat (conduction, convection, radiation), and exposure to light, and chemicals emitted by the produce such as methane and ethylene. Other information that may be input into the system includes the mode of transportation (e.g., truck, train, cargo ship), the transportation routes (intended routes and alternatives thereto), information regarding the transportation carrier and the equipment used to move the produce, location tracking of the transportation vehicle (e.g., GPS tracking), the estimated time the transportation vehicle should arrive at a destination, and events that occur as the goods are in-transit that could affect the time of arrival at the destination. Miscellaneous information may also be input into the system, such as information regarding any warehouses that the produce may be stored in, the locations thereof, and the environmental conditions of the warehouses, e.g., whether they are climate-controlled and could thereby regarded as providing an environment in which expected remaining salable lifetime may be preserved. On the other hand, a warehouse may have a hot and/or humid environment, thereby having a relatively large deteriorating effect on expected remaining lifetime, and such a warehouse may be one to avoid.

Geospatial database system 302 includes attribute levels 316 and calculations region 318. In one embodiment, there are different attribute layers on which data is collected and stored regarding the produce and its travels to its destination, such as a level that collects and stores information regarding the attributes of the produce e.g., information concerning the data of harvest, the initial expected salable lifetime of the produce, the ripeness of the produce, its firmness, its color, its smell, and its state of health (e.g., bruising or absence thereof, and other defects and irregularities). Another level may be an environmental attribute level, for example one in which information regarding the environmental conditions to which the produce is exposed is collected and stored. For example, such information may include temperature, moisture, humidity, heat, chemical emissions and exposure to light, e.g., sunlight. Information on the environmental conditions may be transmitted to the geospatial database system 302 by sensors 306, and the information may be collected and stored on the environmental attribute level.

Another level may be a transportation attribute level, where information regarding the transport of the produce is collected and stored. For example, the information may include the mode of transportation (e.g., truck, train, and cargo ship), information about the transportation carrier, the equipment used to transport the produce, and the information transportation route the produce is expected to take, and alternative routes as well. In one embodiment, this information is input by the system user. In another embodiment, this information is part of an extensive database and for example, the geospatial database generates transportation route information based on the starting point, the final destination, and an estimated fastest route. Other kinds of information may include GPS tracking of the transportation means in order to know the location of the produce at any given time on its route. A GPS sensor may transmit this information to the geospatial database system 302, where it is collected and stored on the transportation attribute level. Other kinds of information that may be stored on the transportation attribute level include the estimated time for the produce to reach its destination and any occurrences or events that occur in-transit that may affect the delivery of the produce to a destination. Such in-transit occurrences may include, for example, road construction delays, weather delays, and accidents. Such information may be input from the system by sensors or other sources, such as monitoring local traffic conditions along the route and by monitoring notifications issued by federal, state, and local agencies regarding road conditions. For example, a state or local police force may issue a warning of an accident that affects traffic, a state or local highway agency may issue a notice informing of the time and place of road construction and associated lane closures. Still further, the database, through the continuous collection of road condition data and the analysis thereof, may identify certain traffic patterns, such as the build-up of traffic on certain roads that may be caused by, for example, blind turns or reduced road visibility that may cause drivers to react by reducing speed. Still further, the system may monitor local weather conditions along the route to determine if weather related events, e.g., rainstorms, snowstorms, road icing, dust, wind, etc., may affect traffic.

The miscellaneous attribute layer collects information for miscellaneous matters. Such matters may include information regarding warehouses where produce may be stored in for periods of time on their journey. Sensor information concerning the environmental conditions in the warehouse, such as the environmental conditions described above, may be transmitted to the geospatial database and stored on the miscellaneous level. Other information that may be stored on the miscellaneous attribute level includes a listing of retail outlets to which the produce may be delivered, should it be considered appropriate to re-route the produce to a destination other than the one that had been intended to receive the delivery. Information on product demand may also be stored on this level.

In calculation region 318, data is analyzed and calculations are performed that relate to the management of produce quality so it will arrive at a final destination, e.g., a point of retail sale, with its remaining expected salable lifetime being maximized. The calculation region is operatively connected to the attribute levels 308 in order to access data and information and to make determination that rely on different data combinations. Merely by way of example, starting with information available from the produce attribute level and the environmental conditions level, determinations may be made on the remaining expected salable lifetime of the produce from the time of harvest, through its travels, to the final destination, e.g., the point of sale. In addition to this information, the calculation region may factor in information collected on the transportation attribute level regarding the mode of transportation, the expected travel routes, location tracking (e.g., through GPS tracking), weather conditions and conditions on the road to estimate times to destination. With such information, an interested person, such a store manager or regional distribution manager, may have a relatively accurate sense of what the condition of the produce will be when it arrives as its destination. That sense may be developed days in advance. Further, since data is collected continuously and in real time, the determinations may be continuously updated, and so that sense may become more reliable as the produce approaches its final destination. Also, should something occur on the road, such as extreme weather, road construction, or road closure, then action that maximizes produce lifetime can be taken based on the analyses and calculations performed in the calculation region. For example, the calculation region may determine that adding a trip to a refrigerated warehouse in order to wait out a storm or road construction could maximize the estimated remaining salable lifetime of the perishable item. In such an example, the calculation region may draw in information from the described attribute levels, e.g., information about the condition of the produce and the estimated initial produce salable lifetime from the produce attribute level, adjustments to the estimated initial produce salable lifetime based on environmental conditions to generate a remaining produce salable lifetime estimate, transportation information that would allow for the determination of an estimate of how much of the produce salable lifetime would remain when the produce reaches the final destination, a further estimate on the benefit of detouring for refrigerated storage, e.g., a comparative adjustment to the remaining salable produce lifetime, and a list of such warehouses as maintained on the miscellaneous attribute level. In yet another example, the calculations region of the geospatial database system may determine that taking an alternative transportation route to avoid a storm or road closure may be the best way to maximize the estimated remaining salable lifetime of the perishable item. In yet another example, the truck may be rerouted to a new store that may be closer to the current location of the truck based on the calculations of the salable lifetime for products. Another example would be to adjust the environment in which the produce is traveling, e.g., adjusting the temperature, humidity, air composition and/or the amount of light to which the produce is exposed. The geospatial database may transmit an instruction to the transportation vehicle to make these adjustments.

The above description of the kind of determination made by the calculations region is indicative of the kind of information that may be output 320 by the geospatial database system. Such output may include information regarding the estimated remaining salable lifetime, expected freshness on arrival, the estimated remaining salable lifetime on delivery, reactions to in-transit occurrences that may affect the delivery schedule, changes to maximize the remaining salable lifetime of the perishable item at the final destination, e.g., at least one of slowing the rate of depletion of remaining salable lifetime, a change in the transportation route, a change in the final destination (e.g., routing to a different final destination), adding a stop at a warehouse, omitting a stop at a warehouse. These are merely examples of the different kinds of output that the system 300 for maintaining produce quality may generate.

In one embodiment the geospatial database system is dynamic, collecting data continuously and making determinations continuously in real time. For example, such information may be continuously updated in real time, as fresh data is collected and calculations are performed.

In one embodiment, information concerning many scheduled and ongoing produce shipments is collected and analyzed simultaneously, and determinations about the shipments of perishable items are also made simultaneously. Many different kinds of produce may be managed by the system, and many different kinds of information regarding the produce and the shipments of same are output from the system. The geospatial database system may exist in a cloud computing environment, it may be locally based, and it may be spread across a vast-reaching computer network.

The above embodiment of system 300 is merely exemplary. Variations of this embodiment and other embodiments altogether that implement the present principles are within the scope of the present disclosure.

Referring to FIG. 6, an exemplary method 400 of maintaining produce quality, in accordance with an embodiment of the present principles, is described. Part or all of method 400 may be performed by system 300 of FIG. 5.

In block 405, a determination of an initial expected salable lifetime of a perishable item is made. In one embodiment, the initial expected salable lifetime may be expressed as a date in the future, for example, “expected to be salable until [future date]”. The determination of the initial expected salable lifetime may be based on experiences in handling and transporting a perishable item, such as an expectancy that a perishable produce item, harvested in a particular date, if maintained under certain conditions, would be expected to be salable until a particular date in the future. Such experiences could be learned from trial and error, and could be based on empirical data. Agricultural organizations, e.g., the U.S. Department of Agriculture or state agricultural organizations, may be sources of such information. An initial estimated salable lifetime determination benchmark value may adjusted in a determination based on factors such as the date of harvest, ripeness of the perishable item (which may be indicative of the timing of the harvest), the firmness of the item, the item's color, the item's smell and other factors, such as the health of the perishable item, e.g., whether it has bruised during handling.

In block 410, data relating to factors that may affect the expected salable lifetime is collected. At the time data collection starts, the perishable item may be within the supply chain, having been transferred from a farm to a transportation carrier, or the time for transfer may be nearing.

In one embodiment, the data relating to factors that may affect the expected salable lifetime may be related to environmental consideration, e.g., considerations relating to the environment to which the perishable item is exposed. Such considerations may be one or more the temperature, the amount of moisture, the amount of humidity, the amount of heat, chemical emissions from the produce, and the amount of light to which the perishable item is exposed.

In block 415, data relating to the transporting of the perishable item is collected. Such data may include the mode of transportation (e.g., truck, train, water-going vessel), information on transportation routes including the intended route (e.g., the initially planned route to reach a final destination), and alternative routes, should it be later decided that the route should be changed. Other transportation-related data that may be collected includes location tracking of the transportation vehicle, e.g., by GPS tracking. The estimated time of arrival at a destination, e.g., the final destination, is data that may be collected. Also, a list including the intended final destination, and alternative final destinations may be collected. Other data that may be collected includes road conditions and weather conditions that will be encountered in-transit (or which are predicted to be encountered), and other transit-related occurrences, such as accidents and emergency road closures. The data that is collected may be taken from sensors associated with the transportation vehicle (e.g., location tracking, estimated time to destination), and it may be taken from various agencies charged with certain responsibilities (e.g., the National Weather Service for weather conditions, the U.S. Department of Transportation and state highway agencies and police departments for conditions on the roads). Other information may input into the system by a system user or operator.

In block 420, miscellaneous data may be collected. For example such data may relate to warehouses and other storage facilities that are part of the supply chain. Such data may relate to information concerning the environmental conditions of the warehouse, e.g., temperature, moisture, humidity, etc., as set forth above. A list warehouses accessible within the supply chain may be collected and stored here. A retail outlet list may also be collected and stored here.

In block 425, a determination is made concerning the remaining expected salable lifetime of the perishable item. The determination may be based on the initial determination of an initial expected salable lifetime and the environmental conditions that would affect the expected salable lifetime of the perishable items. The effect of factors such as temperature, moisture, humidity, chemical emissions etc. on the lifetime of perishable item can be determined from past experience, such as through trial and error based on experimental combinations of different factors, e.g., different combinations of temperature, moisture, heat, humidity, light exposure, etc. and could also be based on empirical data that has been collected and stored. Agricultural organizations, e.g., the U.S. Department of Agriculture, state agricultural organizations, and trade organizations may be sources of such information. This information can be relied upon and factored into the making of the determination of the estimated remaining salable lifetime of the perishable item.

In block 430, a determination is made concerning the remaining expected salable lifetime of the perishable item at the estimated final destination delivery time. The determination is made based on the initial determination of an initial expected salable lifetime, the environmental conditions that would affect the expected salable lifetime of the perishable items, the transportation data, and any miscellaneous data. The determination may be an estimate of the estimated remaining salable lifetime of the perishable item, forecast for the estimated time that the perishable item should arrive at a final destination. The estimated time to destination would be considered in this determination.

Block 435 is a decision block in which a determination is made on whether the estimated remaining salable lifetime of the perishable item at the estimated time of arrival at the final destination can be maximized, e.g., preserved, by making a maximizing change or adjustment as the perishable item travels. If the answer is YES, e.g., a change or adjustment can be made to maximize the estimated remaining salable lifetime, then proceed to block 440. If the answer is NO, e.g., no change or adjustment can be made to maximize the estimated remaining salable lifetime, or no change is necessary, then proceed to block 445.

In block 440, a change or adjustment that slows the rate of depletion of remaining salable lifetime and/or changes the transportation itinerary is made in order to preserve or maximize the estimated remaining salable expected lifetime of the perishable item at the final destination. For example, the environmental conditions in the truck can be changed to slow the rate of depletion of the remaining salable lifetime. Such a change may be lowering temperature, reducing humidity, changing the air composition or changing the exposure to light. A change to the transportation itinerary of the perishable item may be made. For example, the initially selected transportation route may be changed to a transportation route estimated to have an arrival time at the final destination that is sooner than the selected initial transportation route; the initial final destination to may be changed to another final destination estimated to be arrived at sooner than the initial final destination; the perishable items may be delivered and stored at a warehouse that can preserve the salable life for a period of time, and the perishable items may be transferred to a transportation mode that can preserve the salable life for a period of time, e.g., transferring to a refrigerated truck. Still further, plans to store the perishable items may be scrapped or altered, and, in certain circumstances, a truck driver reaching the end of a shift or driving period may be substituted for by a truck driver who is at or near the beginning of a shift.

Block 445 is reached when the answer in determination block 435 is NO. For example, in reaching this block it may be decided that there are no steps to take that would maximize, e.g., preserve, the estimated remaining salable life of the perishable item at the final destination.

In one embodiment, the data collection described in one or more of the blocks 410, 415 and 420 occurs continuously, providing a real time indication of the conditions to which the perishable items are exposed and the effects of same on the estimated remaining salable lifetime, as well as conditions during travel that affect the arrival time of the perishable item as the final destination. In one embodiment, the determinations made in blocks 425 and 430 are made continuously and in real time, providing estimates on the remaining salable lifetime of the perishable item at the present time and at the estimated time of delivery at the final destination. Likewise, the determinations made in block 435 regarding whether the estimated remaining salable lifetime of the perishable item can be maximized, e.g., preserved, and the ways the lifetime can be maximized, may also be made continuously and in real time.

While the embodiment of the method described above indicates that the estimated remaining salable lifetime is determined to give a present time value (e.g., block 425) and determined to give a value at the estimated time of delivery at the final destination (e.g., block 430), it should be understood that it is possible that one of these determinations does not have to be made. For example, the block 425 determination alone may provide information sufficient to make a decision in block 435 on whether the estimated remaining salable lifetime of the perishable item can be maximized, e.g., preserved. A block 430 determination alone may provide information sufficient to make a decision in block 435 on whether the remaining salable lifetime of the perishable item can be maximized, e.g., preserved.

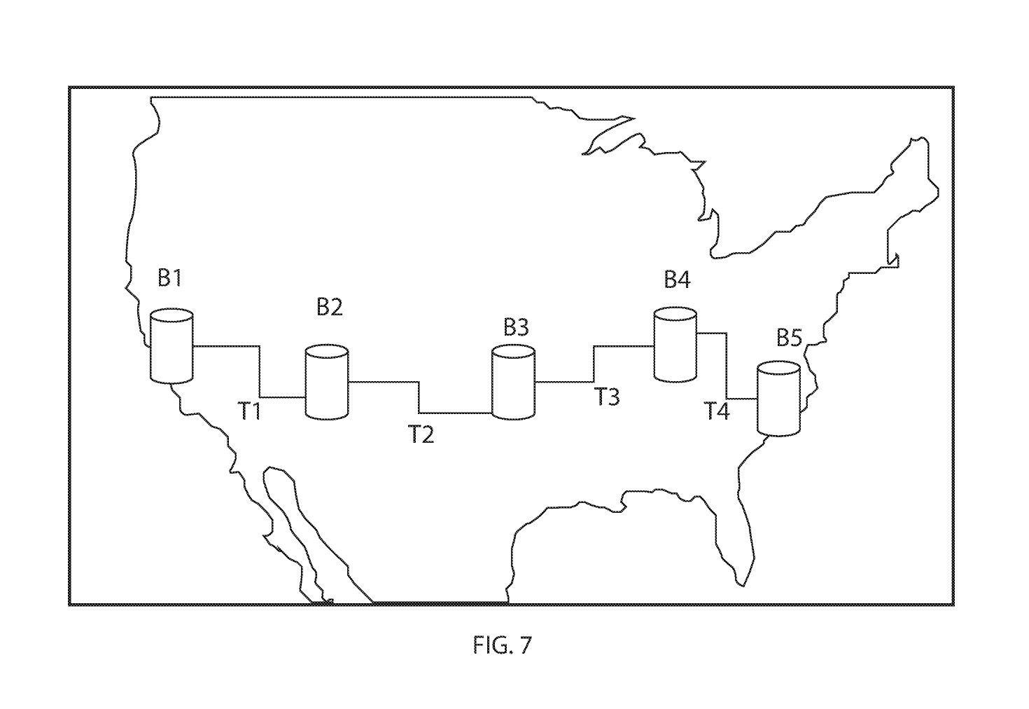

FIG. 7 depicts a transportation route for transporting perishable farm products from California to the east coast of the United States. According to the route shown, the farm products may be transported in multiple stages, e.g., between travel legs T1, T2, T3, and T4 across the country, the produce may be stored in one or more warehouses B1, B2, B3, B4, and B5 located along the route for the time periods indicated below. Environmental condition data may be collected at the warehouses and transmitted to the geospatial database, where the information is collected and stored on one or more attribute levels. By way of example, the following data may be collected at the warehouses, and transmitted to the geospatial database:

B1: 1.4 days at 5° C.;

B2: 0.5 days at 9° C.;

B3: 0.75 days at 5° C. (relative humidity 75%);

B4: 2.0 days at 10° C.; and

B5: 1.3 days at 10° C.;

Since the expected storage time and environmental conditions in all potential warehouses are known as the produce begins its travels across the country, the geospatial database may attempt to provide an optimized route T1, T2, T3 and T4 that is shortest in time and in which maintains the produce in an optimized temperature range. The environmental conditions in the different trucks that haul the farm products may change along the route. From information of this kind, the geospatial database may determine the estimated remaining salable lifetime of the perishable farm products based on real time data collected by the database.

Different combinations of routes and warehouses are analyzed by the geospatial database in order to minimize the cost of transportation and to preserve the longest possible expected salable lifetime of the farm products. It may be possible that skipping one or more warehouses is preferred to expedite the delivery and best preserve the estimated remaining salable lifetime at the final destination.

Table 1 compares different route combinations and temperatures that may be expected along the route. The data is considered by the geospatial database.

TABLE 1

| | Temp | | Temp | | Temp | | Temp | E.R.S.L. |
|---|---|---|---|---|---|---|---|---|
| P.R.S. | (° C.) | P.R.S. | (° C.) | P.R.S. | (° C.) | P.R.S. | (° C.) | (Days) |
| T1 (B2) | 16 | T2(B3) | 18 | T3 | 16 | T4 | 18 | 3.1 |
| | | | | (B4) | | (B5) | | |
| T1 + T2 | 16 | T3(B4) | 18 | T4 | 18 | | | 4.3 |
| (B3) | | | | (B5) | | | | |
| T1 + T2 | 16 | T3 + T4 | 18 | | | | | 4.4 |
| (B3) | | (B5) | | | | | | |
| T1 + T2 + | 16 | T4(B5) | | | | | | 6.6 |
| T3 (B4) | | | | | | | | |

P.R.S. is the proposed route segment and E.R.S.L is the estimated remaining salable lifetime.

The geospatial database determines the expected remaining salable lifetime at the final destination while considering the minimization of storage and transportation costs. In the present example the final destination is a warehouse B5 on the east coast. The geospatial database generates possible transportation routes that would deliver the perishable farm products to B5 with the following expected remaining salable lifetimes: 3.1 days, 4.3 days, 4.4 days and 6.6 days. From B5, the perishable farm products are distributed to one or more retail stores e.g., supermarkets. The geospatial database may be used to determine the expected remaining salable lifetime of the perishable farm products when they arrive at the retails stores, based on the time spent in B5 and the estimated time of delivery at the retail stores. Such an estimate would be based on the environmental conditions at B5 and in the modes of transportation (e.g., trucks) that deliver the produce to the retail stores. Store customer data and customer shopping habits may be accounted for by the geospatial database in determining how fresh the items may be, e.g., how much expected remaining salable lifetime must remain as the produce is stocked in the supermarkets.

The method of maintaining produce quality offers several advantages. For example, produce should arrive at a point of sale with its expected remaining salable lifetime being preserved and maximized. The consumer benefits by being able to purchase and consume perishable items that may have traveled long distances that are in their freshest possible state. Shelf life at home is increased, which should lead to less waste on the part of the consumer. The seller, the transporter and others in the supply chain may also benefit. Fresher goods should command a higher price at market, and less of the goods should have to be disposed of because they have reached a point where they are no longer sellable. The transporter benefits because there should be less discounts for delivering sub-par goods. The distributer benefits because there is better control and management of the perishable items through the supply chain.

While the present disclosure includes a detailed description on cloud computing, it should be understood that implementation of the subject matter described herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

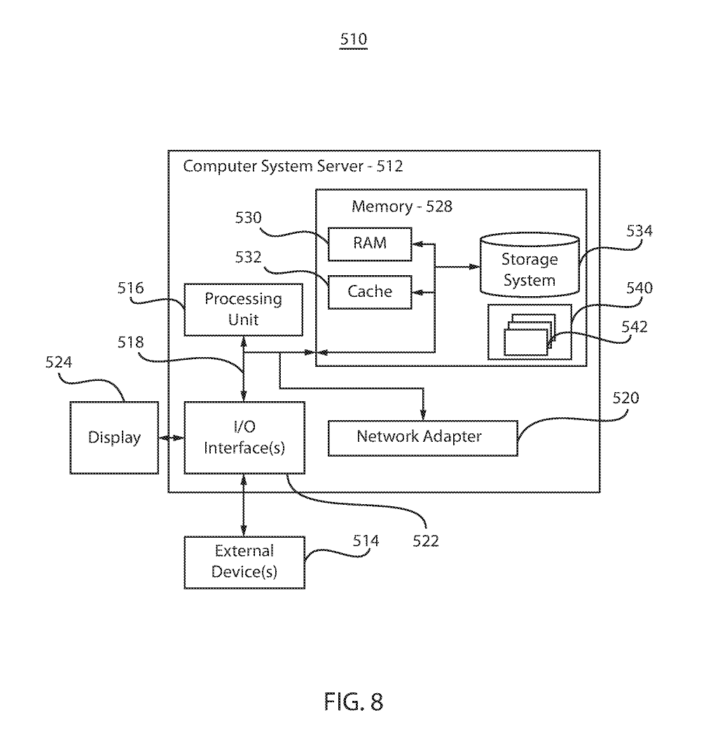

Referring now to FIG. 8, a schematic of an example of a cloud computing node 510 is shown. Cloud computing node 510 is only one example of a suitable cloud computing node and is not intended to suggest any limitation as to the scope of use or functionality of embodiments of the invention described herein. Regardless, cloud computing node 510 is capable of being implemented and/or performing any of the functionality set forth hereinabove.

In cloud computing node 510 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 512 may be described in the general context of computer system executable instructions, such as program modules, being executed by a computer system. Generally, program modules may include routines, programs, objects, components, logic, data structures, and so on that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 512 in cloud computing node 510 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 512 typically includes a variety of computer system readable media. Such media may be any available media that is accessible by computer system/server 512, and it includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein.

Computer system/server 512 may also communicate with one or more external devices 514 such as a keyboard, a pointing device, a display 524, etc.; one or more devices that enable a user to interact with computer system/server 512; and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples include, but are not limited to: microcode, device drivers, redundant processing units, external disk drive arrays, RAID systems, tape drives, and data archival storage systems, etc.

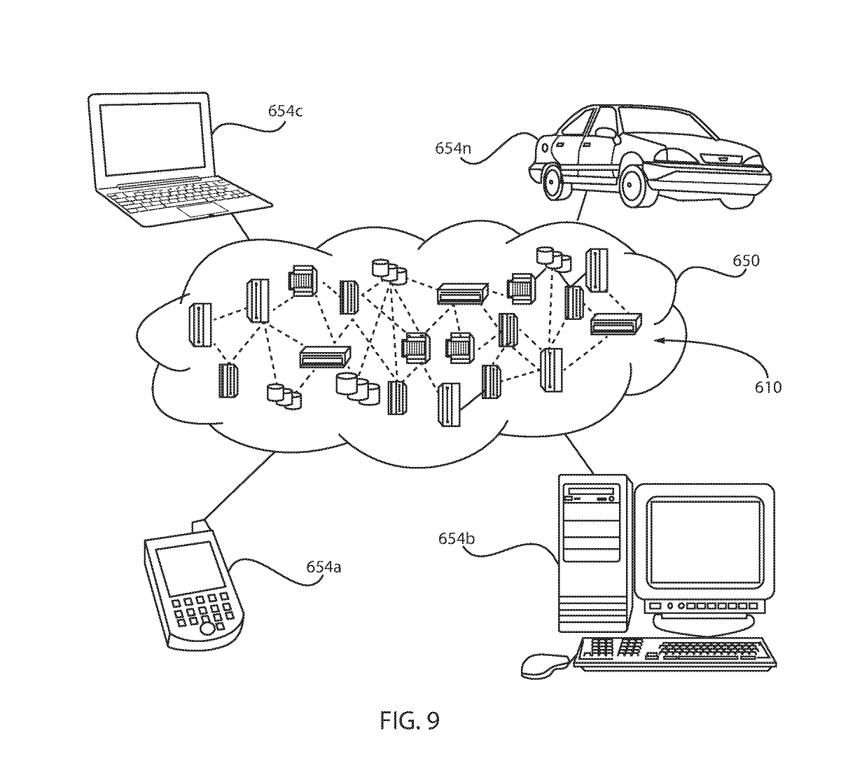

Referring now to FIG. 9, illustrative cloud computing environment 650 is depicted. As shown, cloud computing environment 650 comprises one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as services for which a cloud consumer does not need to maintain resources on a local computing device. It is understood that the types of computing devices 654A-N shown in FIG. 9 are intended to be illustrative only and that computing nodes 610 and cloud computing environment 650 can communicate with any type of computerized device over any type of network and/or network addressable connection (e.g., using a web browser).

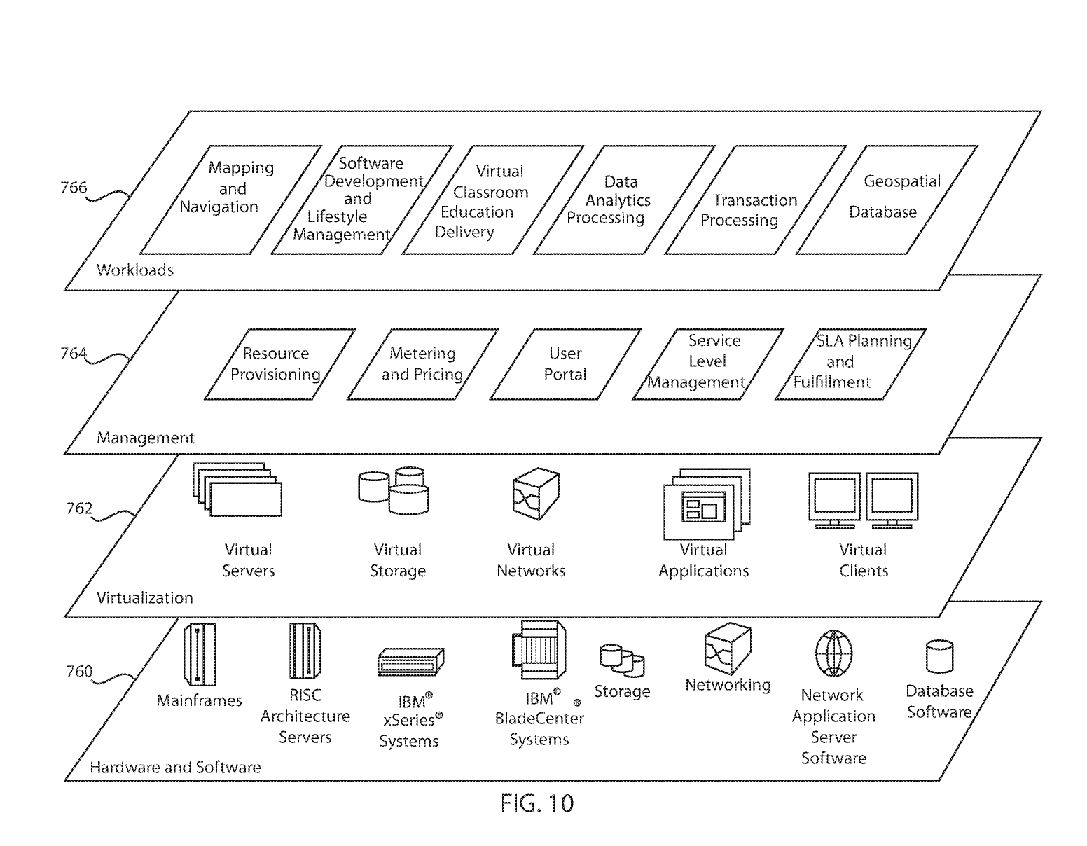

FIG. 10 shows a set of functional abstraction layers provided by cloud computing environment 650. It should be understood in advance that the components, layers, and functions shown in FIG. 10 are intended to be illustrative only and embodiments of the invention are not limited thereto. As depicted, the following layers and corresponding functions are provided:

Hardware and software layer 760 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 762 provides an abstraction layer from which the following examples of virtual entities may be provided: virtual servers; virtual storage; virtual networks, including virtual private networks; virtual applications and operating systems; and virtual clients.

In one example, management layer 764 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 766 provides examples of functionality for which the cloud computing environment may be utilized. Examples of workloads and functions which may be provided from this layer include: mapping and navigation; software development and lifecycle management; virtual classroom education delivery; data analytics processing; transaction processing; and geospatial database.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method of managing the quality of perishable items traveling in a supply chain (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method of managing quality of perishable items traveling in a supply chain, comprising:
determining an initial estimated salable lifetime of perishable items;
in real time, reducing the initial estimated salable lifetime to an estimated remaining salable lifetime in a determination based on information comprising one or more conditions relating to the environment to which the perishable items are exposed and the transporting of the perishable items to a final destination;
determining, in a hardware processor, a manner of preserving the estimated remaining salable lifetime of the perishable items by at least one of slowing the depletion of the estimated remaining salable lifetime and changing a transportation itinerary of the perishable items; and
performing at least one of slowing the depletion of the estimated remaining salable lifetime and changing the transportation itinerary in accordance with the determination to preserve the estimated remaining salable lifetime of the perishable items.

2. The method of claim 1, further comprising collecting and storing the information used in making the determination of an initial estimated salable lifetime and the information comprising one or more conditions relating to the environment to which the perishable items are exposed and the transporting of the perishable items to a final destination in a geospatial database configured to manage the quality of perishable items moving in a supply chain.

3. The method of claim 1, wherein the determining of the initial estimated salable lifetime of the perishable items is based on information comprising one or more of time of harvest, an initial estimated salable lifetime determination benchmark value, and indicia selected from one or more of ripeness, firmness, color, smell and health of the perishable time.

4. The method of claim 1, wherein the information comprising one or more conditions relating to the environment to which the perishable items are exposed comprises collected information that includes one or more of temperature, moisture, humidity, heat and exposure to light to which the perishable items are exposed, and chemical emissions from the perishable items.

5. The method of claim 1, wherein information comprising the transporting of the perishable items to a final destination comprises collected information that includes one or more of mode of transportation, the selected transportation route, location tracking of the transportation mode, the estimated time to destination, alternative transportation routes, weather conditions, road conditions, and in-transit occurrences affecting arrival time at the final destination.

6. The method of claim 1, further comprising collecting and storing data comprising information concerning the delivery of the perishable items to a storage location within the supply chain.

7. The method of claim 1, wherein the reducing of the initial estimated salable lifetime comprises reducing the initial estimated salable lifetime to the estimated remaining salable lifetime based on information that has been collected comprising one or more conditions relating to the environment that include the temperature to which the perishable items are exposed, the moisture to which the perishable items are exposed, the humidity to which the perishable items are exposed, the heat to which the perishable items are exposed, chemical emissions from the perishable items, and the amount of light to which the perishable items are exposed.

8. The method of claim 1 wherein the determining of a manner of preserving the estimated remaining salable lifetime comprises one or more of:
changing the environment to which the perishable items are exposed by one or more of reducing temperature, reducing humidity, changing the air composition and reducing light to which the perishable items are exposed; changing the transportation route from a selected initial transportation route to a transportation route estimated to have an arrival time at the final destination that is sooner than the selected initial transportation route; changing the final destination to another final destination estimated to be arrived at sooner than the final destination; for a period of time, delivering and storing the perishable items to a storage location exhibiting salable life-preserving conditions; and transferring the perishable items to a transportation mode exhibiting salable life-preserving conditions.

9. The method of claim 1, wherein a collecting of information comprising one or more conditions relating to the environment to which the perishable items are exposed and the transporting of the perishable items to a final destination and the reducing the initial estimated salable lifetime to the estimated remaining salable lifetime occur continuously as the perishable items are in transit.

10. A system for managing quality of perishable items traveling in a supply chain, comprising:
one or more processors including memory;
a geospatial database system comprising:
one or more inputs through which information concerning the perishable items and the transporting of same are delivered to the system;
data storage levels configured to collect and store data concerning the perishable items, the environmental conditions to which the perishable items are exposed, and the transporting of the perishable items to a final destination;
a calculation region in which, based on the data, an estimated remaining salable lifetime of the perishable items and manners of preserving the estimated remaining salable estimated lifetime of the perishable items are determined; and
outputs in which collected data and determinations are distributed.

11. The system of claim 10, wherein the one or more inputs comprise sensors that are in operative communication with the geospatial database system, the sensors collecting information concerning one or more of the following conditions to which the perishable items are exposed: temperature, moisture, humidity, heat, exposure to light, and chemical emissions from the perishable items, the information being collected and stored on a data storage level of the geospatial database system.

12. The system of claim 10, wherein the one or more inputs comprise sensors that are in operative communication with the geospatial database system, the sensors being associated with a mode of transportation in which the perishable items are traveling, the sensors collecting information concerning one or more of the following: location tracking, speed, and environmental conditions to which the transportation mode is exposed, the information being collected and stored on a data storage level of the geospatial database system.

13. The system of claim 10, wherein the geospatial database system is configured to collect and store information concerning the determining of an estimated remaining salable lifetime of the perishable items based on one or more factors comprising the time of harvest, an initial salable lifetime determination, and indicia comprising ripeness, firmness, color, smell and health of the perishable time, the information being collected and stored on a data storage level of the geospatial database system.

14. The system of claim 10, wherein the geospatial database system is configured to collect and store information concerning the determining of an estimated remaining salable lifetime of the perishable items based on one or more factors comprising temperature, moisture, humidity, heat, and the exposure to light to which the perishable items are exposed and chemical emissions from the perishable items, the information being collected and stored on a data storage level of the geospatial database system.

15. The system of claim 10, wherein the geospatial database system is configured to collect and store information concerning the transporting of the perishable items to a final destination based on one or more factors comprising the mode of transportation, the selected transportation route, location tracking of the transportation mode, the estimated time to destination, alternative transportation routes, weather conditions, road conditions, and in-transit occurrences affecting arrival time at the final destination, the information being collected and stored on a data storage level of the geospatial database system.

16. The system of claim 10, wherein the geospatial database system is configured to determine the estimated remaining salable lifetime of the perishable items through a determination comprising reducing an initial estimated salable lifetime of the perishable items to an estimated remaining salable lifetime of the perishable items based on one or more factors comprising temperature to which the perishable items are exposed, moisture to which the perishable items are exposed, humidity to which the perishable items are exposed, heat to which the perishable items are exposed, amount of light to which the perishable items are exposed, and chemical emissions from the perishable items.

17. The system of claim 10, wherein the geospatial database system is configured to determine a manner of preserving the estimated remaining salable lifetime by generating information comprising one or more of:
changing the environment to which the perishable items are exposed by one or more of reducing temperature, reducing humidity, changing the air composition and reducing light to which the perishable items are exposed; changing the transportation route from a selected initial transportation route to a transportation route estimated to have an arrival time at the final destination that is sooner than the selected initial transportation route; changing the final destination to another final destination estimated to be arrived at sooner than the final destination; for a period of time, delivering and storing the perishable items to a storage location exhibiting salable life-preserving conditions; and transferring the perishable items to a transportation mode exhibiting salable life preserving conditions.

18. The system of claim 10, wherein the one or more inputs comprise sensors in operative communication with the geospatial database system that continuously send data to the system.

19. The system of claim 10, wherein the geospatial database system is configured to continuously perform one or more of collecting and storing data, determining the estimated remaining salable lifetime of the perishable items, and determining the manner of preserving the estimated remaining salable estimated lifetime of the perishable items.

20. A computer program product of managing quality of a perishable items traveling in a supply chain, the computer program product comprising a non-transitory computer readable storage medium having program instructions embodied therewith, the program instructions being executable by a computer to cause the computer to perform a method comprising:
determining an initial estimated salable lifetime of perishable items;
in real time, reducing the initial estimated salable lifetime to an estimated remaining salable lifetime in a determination based on information comprising one or more conditions relating to the environment to which the perishable items are exposed and the transporting of the perishable items to a final destination;
determining a manner of preserving the estimated remaining salable lifetime of the perishable items by at least one of slowing the depletion of the estimated remaining salable lifetime and changing a transportation itinerary of the perishable items; and
performing at least one of slowing the depletion of the estimated remaining salable lifetime and changing the transportation itinerary in accordance with the determination to preserve the estimated remaining salable lifetime of the perishable items.
